(19) United States
(12) Patent Application Publication
(10) Pub. No.: US 2016/0172092 A1
(43) Pub. Date: Jun. 16, 2016

(54) Method and equipment for magnetic nanopatterning of substrates

(71) Applicants: POLITECNICO DI MILANO, Milano (IT); GEORGIA TECH RESEARCH CORPORATION, Atlanta, GA (US)

(72) Inventors: Riccardo BERTACCO, Morazzone (IT); Daniela PETTI, Milano (IT); Edoardo ALBISETTI, Milano (IT); Elisa RIEDO, Atlanta, GA (US)

(21) Appl. No.: 14/938,939

(22) Filed: Nov. 12, 2015

(30) Foreign Application Priority Data
Nov. 12, 2014 (EP) 14425144.4

(51) Int. Cl. H01F 13/00

(52) U.S. Cl. CPC H01F 13/003

(57) ABSTRACT

Method for magnetic nanopatterning of a substrate 10, said substrate comprising a first ferromagnetic or ferrimagnetic phase FM and a second antiferromagnetic phase AF, said FM and AF phases being coupled by exchange bias in such a way to form an exchange bias system; said method comprising submitting said substrate to a magnetic field H_{w} so as to set the magnetization of said first phase FM in the direction of said magnetic field H_{w}, while heating predefined portions of said antiferromagnetic phase AF up to a writing temperature T_{W} at which the exchange bias can be influenced, equipment for carrying out said method and substrate nanopatterned according to said method.

### FIELD OF THE PRESENT INVENTION

The present invention relates to the field of nanomagnetism and spintronics. In particular, the present invention relates to the magnetic nanopatterning of substrates.

More particularly, the present invention relates to the writing of magnetic information on substrates. In more detail, the present invention relates to the thermally assisted magnetic nanopatterning of substrates. Still in more detail, the present invention relates to a method and corresponding equipment for magnetically patterning substrates, as well as for magnetically patterning physically pre-patterned substrates.

### STATE OF THE ART

It is well known that magnetism intrinsically represents a very efficient solution to write readable information in a substrate, essentially because the hysteretic behaviour of hard materials provides both remanence and rewritability. This is the basis for the large success of magnetic memories (tapes, hard disks, non-volatile magnetic random access memories), where the writing of magnetic information at the micro and nano-scale is achieved via magnetic and electric fields, and currents.

During the last years, in particular, several efforts have been dedicated to the development of magnetic patterned media for various applications such as, for example, magnetic logics, spintronics, magnonics, plasmonics, memory devices, manipulation of nanoparticles carrying biological entities or the like.

However, even if, on the one side, the results achieved by means of the technologies just mentioned above may be regarded as being quite satisfactory (as well as quite promising as to further achievements), the most known and implemented technologies are, on the other side, still affected by several drawbacks.

For instance, the fabrication of magnetic micro and nanostructures has been carried out so far essentially with a top-down approach, using either lithography or ion irradiation. In the former case, the continuous stack including magnetic materials is etched to define the pattern, while in the latter ion irradiation is used to destroy the magnetic properties out of the selected pattern, in a continuous film. However, these solutions are affected by the main drawback that same are destructive and irreversible; moreover, the search for inexpensive ways of patterning magnetic structures on surfaces and/or substrates is of capital importance in commercial applications.

In this scenario, there is an increasing need of patterning techniques for fabricating novel reconfigurable magnetic meta-materials, implementing complex logic functionalities at the nanoscale.

The main scope of the present invention is therefore that of presenting a valid alternative to the present technology, and of overcoming (or at least minimizing) some of the drawbacks and/or problems affecting the prior art.

In particular, a further scope of the present invention is that of providing an innovative solution allowing the patterning of areas and/or portions of a substrate. As a further goal, the solution according to the present invention shall allow to pattern surfaces and/or substrates according to a non-destructive technology. Moreover, and still according to the present invention, the (lateral) dimensions of the patterned structure shall belong to the nanoscale. Furthermore, the remanent configuration of patterned areas shall be resistant against external influences such as, for example, magnetic and/or electric fields or the like. A further goal of the present invention is that of introducing a new technology allowing patterned areas to be selectively cancelled and repatterned, or even completely erased by re-initializing the whole substrate or film.

### BRIEF DESCRIPTION OF THE PRESENT INVENTION

Considering the above purposes and/or goals, the present invention is based on the general idea according to which stable, readable and rewritable patterns may be efficiently and easily written in a substrate including an exchange bias system, said system comprising an antiferromagnetic phase and a ferromagnetic phase, by creating in said substrate predefined portions with different magnetic properties. In particular, according to a further consideration on which the present invention is based, the exchange bias field inside said predefined portions shall be at any angle (e.g. antiparallel) with respect to the exchange bias field outside said predefined portions, said predefined portions being therefore adapted to implement pre-designed material functionalities. In particular they can be recognized, thus representing readable information. In said system, the temperature above which the exchange bias disappears is called ‘blocking temperature’ (T_{B}).

According to the present invention a novel technique for magnetic nanopattering is therefore proposed, said technique being based on thermally assisted magnetic scanning probe lithography (in the following also referred to as tam-SPL), which combines the tunability and full reversibility of exchange bias with the resolution and versatility of scanning probe lithography. Still according to the present invention, an exchange bias system, made of a ferromagnetic (FM) phase exchange coupled to an antiferromagnetic (AF) phase (with blocking temperature above room temperature), can be first initialized with a uniform field cooling, which sets the unidirectional anisotropy and shifts the hysteresis loop, so that the magnetization of the FM is pinned in one direction. Depending on the peculiar exchange bias system, initialization can be achieved also in a different way, with any method suitable to obtain an initial exchange bias configuration over the entire substrate which allows to distinguish the patterned area after lithography, e.g. a null exchange bias or a uniformly noisy exchange bias landscape. The hot tip of a scanning probe microscope (SPM), operated in the closed loop lithographic mode, is used to locally heat the system above the blocking temperature during the scan in an applied external field. When sweeping the tip, the portion of the substrate in contact with the tip is heated and then, when the tip is displaced, it cools down again to room temperature due to thermal dissipation. This highly localized field cooling allows for writing exchange-biased domains with arbitrary shape and anisotropy axis at any angle with respect to that set during initialization. In particular, the present invention allows the writing of micro-and nano-domains with arbitrary shape, having unidirectional anisotropy at any angle with respect to a reference direction which can be the initialization axis, in particular in hetero structures Ru(2)/IrMn(7)/CoFeB(5)/SiO2(1000)/Si (thickness in nm), where the AF and FM phases correspond to adjacent films. The present invention offers therefore the possibility of writing vectorial information, beyond the usual binary code (up-down magnetization). Arbitrary domain shapes (e.g. squares, triangles and stripes) with minimum size as low as a few tens of nm may be written and imaged, according to the present invention, with any kind of suitable magnetic imaging technique, such as magnetic force microscopy (MFM) and magneto optical Kerr effect microscopy (-MOKE). The relevant advantages of the present invention relate to the facts that: (i) the writing technology is non-destructive, (ii) the remanent state of patterned exchange-biased domains is very robust against external magnetic fields, (iii) patterned areas can be selectively cancelled and rewritten at will by local field cooling in opposite magnetic field, or completely erased by re-initializing the whole film, (iv) the unidirectional anisotropy strength can be tuned by controlling the tip temperature during writing. The last feature, in particular, is very appealing as it allows to nano-fabricate artificial magnetic meta-materials from a magnetic substrate, by patterning a pre-defined magnetic anisotropy landscape with sub-micron resolution. This is a completely new scenario, paving the way to the design of novel architectures for magnetic logic, memory and spintronic devices, with high potential both for fundamental research and applications in the field of nanomagnetism and spintronics. On the basis of the above considerations a first embodiment of the present invention relates to a method as claimed in claim 1, namely a method for magnetic nanopatterning of a substrate, said substrate comprising a ferromagnetic phase (FM) and an antiferromagnetic phase (AF), said phase (FM) and said phase (AF) being coupled by exchange bias in such a way to form an exchange bias system; said method comprising:

Submitting the substrate to a magnetic field H_{W} oriented at any angle with respect to a reference direction of the substrate so as to set the magnetization of said first phase (FM) in the direction of said magnetic field H_{W}, while heating predefined portions of said antiferromagnetic phase (AF) up to a writing temperature T_{W} at which the exchange bias can be influenced;

Allowing said predefined portions of said antiferromagnetic phase (AF) to cool down to a temperature T_{f} below T_{w};

Removing said magnetic field H_{w}.

According to a further embodiment, said writing temperature T_{w} is above the blocking temperature T_{B}.

Still according to a further embodiment, said predefined portions of said antiferromagnetic phase AF are allowed to cool down to a temperature T_{f} which coincides with the room temperature.

According to a further embodiment, during initialization via uniform field cooling of said substrate, said substrate is cooled down to the room temperature.

For instance, said room temperature may be comprised between −40 and +125° C.

According to a further embodiment, the method of the present invention may even comprise forming said ferromagnetic phase FM and said antiferromagnetic phase AF, wherein during formation of said ferromagnetic phase FM said ferromagnetic phase FM is submitted to an in-plane magnetic field H_{G} so as to set the uniaxial anisotropy axis of said ferromagnetic phase FM. For instance, said magnetic field Hᵢ used for initialization may be either parallel to said magnetic field H_{G} or oriented at any angle with respect to said magnetic field H_{G}. Still by way of example, the intensity of said magnetic field H_{G} may be comprised between 0 and 1000 Oe and/or the intensity of said magnetic field Hᵢ may be comprised between 0 and 50000 Oe or even the intensity of said magnetic field H_{W} may be comprised between 0 and 50000 Oe.

According to further embodiments, said antiferromagnetic phase AF comprises IrMn and/or the thickness of said antiferromagnetic phase AF is comprised between 0 and 100 nm and/or said ferromagnetic phase FM comprises CoFeB and/or the thickness of said ferromagnetic phase FM is comprised between 0 and 100 nm and/or said substrate comprises a support layer, said exchange bias system being provided on said support layer. According to still further embodiments, said support layer comprises a semiconductive or insulating material such as Si, SiO₂ or the like and/or said substrate comprises a protective layer provided on said exchange bias system, for instance comprising Ru and/or with a thickness comprised between 0 and 100 nm

Further embodiments of the method according to the present invention are defined in the dependent method claims.

The present invention further relates to an equipment for carrying out the above method, namely an equipment for magnetic nanopatterning of a substrate according to the above method, said substrate comprising a first ferromagnetic phase (FM) and a second antiferromagnetic phase (AF), said (FM) phase and said (AF) phase being coupled by exchange bias; said equipment comprising:

Means for generating a magnetic field H_{W} oriented at any angle with respect to a reference direction so as to expose said substrate to said magnetic field H_{W}, thus setting the magnetization of said (FM) phase in the direction of said magnetic field H_{W};

Means for heating predefined portions of said antiferromagnetic phase (AF) up to said temperature T_{W} at which the exchange bias can be influenced whilst said substrate is exposed to said second magnetic field H_{W};

Means for allowing said predefined portions of said antiferromagnetic phase (AF) to cool down to a temperature below said temperature T_{W};

Means for removing said magnetic field H_{W}.

Further embodiments of the equipment according to the present invention are defined in the dependent claims.

Still according to the present invention there is provided a readable substrate, i.e. a substrate with readable information written in it, namely a magnetically patterned substrate, said substrate comprising a ferromagnetic phase (FM) and an antiferromagnetic phase (AF); wherein, within predefined portions of said ferromagnetic phase (FM), the exchange bias field Hₑₚ has a different direction with respect to the exchange bias field Hₑ of the ferromagnetic phase (FM) outside said predefined portions.

According to an embodiment said antiferromagnetic phase AF comprises IrMn.

For instance, the thickness of said antiferromagnetic phase AF may be comprised between 0 and 100 nm According to an embodiment, said ferromagnetic phase FM may comprise CoFeB, wherein the thickness of said ferromagnetic phase FM) may be for instance comprised between 0 and 100 nm

According to further embodiments said substrate may comprise a support layer, said exchange bias system being provided on said support layer, said support layer comprising for instance a semiconductive material such as Si or the like, or an insulating material such as SiO₂ or the like and/or said substrate may comprise a protective layer provided on the exchange bias system, said protective layer comprising for instance Ru, the thickness of said protective layer being for instance comprised between 0 and 100 nm.

Further embodiments of the substrate according to the present invention are defined in the dependent claims.

### BRIEF DESCRIPTION OF THE DRAWINGS

In the following, the present invention will be clarified by means of the following detailed description of the embodiments of the present invention depicted in the drawings, wherein equivalent and/or corresponding features are identified by the same reference numerals and/or signs; in particular, in the drawings:

FIGS. 1a to 1c show the relevant steps of the method according to the embodiment of the present invention depicted therein;

FIGS. 1d and 1e show the hysteresis loops of the substrate depicted in FIGS. 1a to 1c once the method steps depicted in FIGS. 1a and 1c, respectively, have been carried out;

FIGS. 2a to 2d show images of features patterned on a substrate according to the method of the present invention;

FIGS. 3a to 3d show that it is possible to tune the magnetic anisotropy by controlling the tip temperature during writing;

FIGS. 4a to 4c show the reversibility and local reconfigurability of the domains patterned according to the method of the present invention;

FIG. 5 shows the robustness of domains patterned according to the present invention when subjected to different magnetic fields.

FIG. 6 shows schematically an equipment according to an embodiment of the present invention for patterning a substrate;

### DETAILED DESCRIPTION OF THE PRESENT INVENTION

The present invention has revealed to be particularly convenient when used for patterning shapes, portions and/or areas of a substrate with peculiar magnetic anisotropy configurations, as well as for writing readable information on a layered substrate. This is therefore the reason why, in the following, description will be given of the present invention when used for patterning shapes, portions and/or areas of a substrate, as well as for writing readable information on a layered substrate, where AF and FM phases are adjacent films. It has however to be noted that the possible uses and/or applications of the present invention are neither limited to the patterning of shapes, portions and/or areas of a substrate, nor to the writing of readable information on a substrate. To the contrary, the possible uses and/or applications of the present invention may comprise as well the patterning of: magnetic logic circuits, magneto-optical waveguides, magneto-plasmonic devices, magnonic crystals.

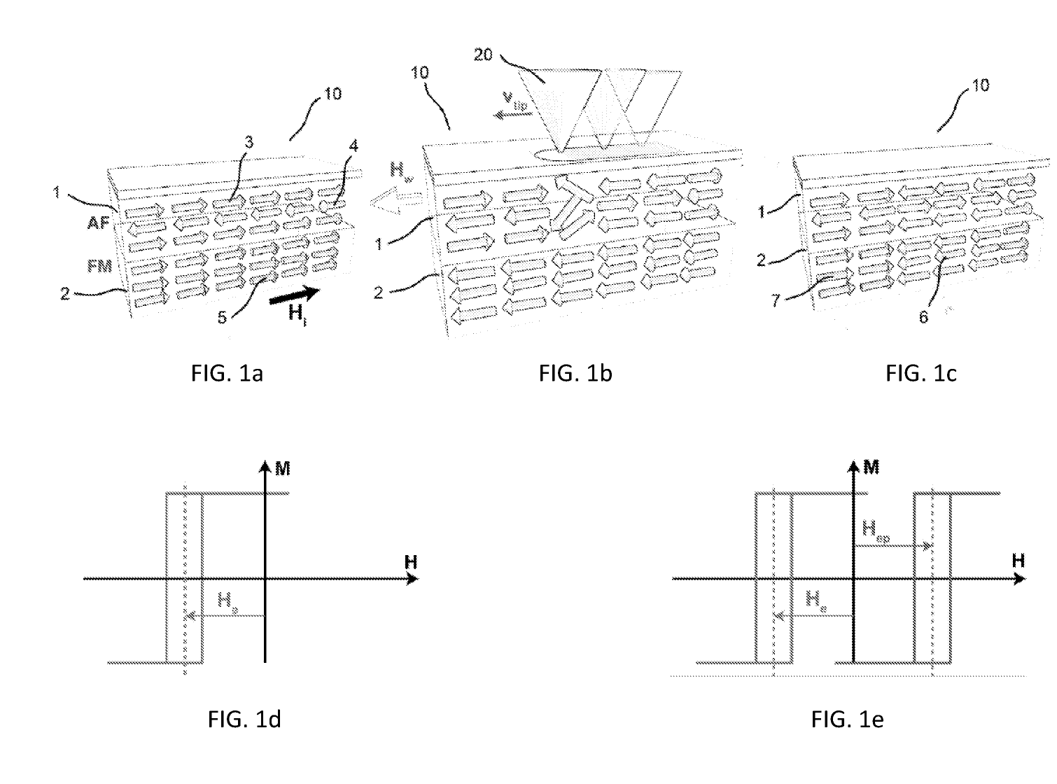

The support for magnetic patterning depicted in FIG. 1 is a multilayer 10, grown by magnetron sputtering, with the following structure: Ru(2)/IrMn(7)/CoFeB(5)/SiO2(1000)/Si (thickness in nm), wherein Ru is provided as covering and/or protective layer or film, IrMn represents the AF phase 1, CoFeB represents the FM phase 2, and SiO₂/Si is provided as supporting layer (not depicted); it has however to be noted that different and/or alternative and/or additional ferromagnetic, ferrimagnetic and/or antiferromagnetic materials may be used within the scope of the present invention, wherein said materials preferably present a sizable exchange bias coupling with blocking temperature T_{B} (i.e. the temperature above which exchange bias vanishes) above room temperature.

An in-plane magnetic field H_{G}=300 Oe (not depicted) can be applied during formation, in particular deposition of the multilayer 10, to set the uniaxial anisotropy axis (UA) of the FM phase 2.

The basic principle of the thermally assisted magnetic scanning probe lithography (tam-SPL) method according to the present invention is schematically represented in FIG. 1 with reference to the simplest case, i.e. when exchange biased domains with antiparallel remanent magnetization with respect to the unpatterned areas are written. The first step of the tam-SPL method according to the present invention (FIG. 1a) is the multilayer initialization, which sets a sort of uniform anisotropy landscape. This can be achieved via field cooling in applied field Hᵢ, which sets a uniform unidirectional anisotropy axis (UD) in the FM phase 2, thus shifting its hysteresis loop due to the exchange bias field Hₑ (see FIG. 1d); in particular, with the magnetic field Hᵢ applied to the substrate 10, the AF phase 1 is first heated to a temperature above the blocking temperature and subsequently allowed to cool down to a temperature below the blocking temperature T_{B} of the exchange bias system, for instance to room temperature. As a result, the magnetization of the FM phase 2 is pinned in one direction. Depending on the peculiar exchange bias system, initialization can be achieved also in a different way, e.g. it can be obtained by using patterned substrates or even substrates grown in applied field. Any method suitable to obtain an initial exchange bias configuration over the entire substrate which allows to distinguish the patterned area after lithography, e.g. a null exchange bias or a uniformly noisy exchange bias landscape, can be also used for initialization.

The magnetic configuration of this “clean blackboard” state obtained after initialization is sketched in FIG. 1a, where arrows identified by reference numerals 3 and 4 pictorially represent the spins of the two spin sub-lattices in the AF (IrMn) phase or layer 1 and arrows identified by reference numerals (5) identify the spins of the FM (CoFeB) phase or layer 2, all pointing to the right. The corresponding hysteresis loop is reported in FIG. 1d, where the exchange bias field Hₑ is also indicated.

The patterning step (FIG. 1b) is performed with an SPM operating in the closed-loop nanolithography mode, by applying a uniform static magnetic field H_{W}, which, for instance, can be of 700 Oe and opposite to the initialization field Hᵢ (or oriented at any angle with respect to Hᵢ), while scanning the area to be patterned with a hot tip 20, set at a temperature T_{W} at which the exchange bias can be influenced, for instance above T_{B}. When the tip 20 passes above a portion of the substrate 10 and heats it up to T_{W}, the exchange bias is locally altered and/or even destroyed, while, at the same time, the magnetization of the FM layer or phase 2 is set in the direction of H_{W}. When the heating source (the hot tip) is displaced in its motion along the scanning direction or path, the AF phase 1 undergoes a “local field cooling” which re-establishes the exchange bias along a direction set by the external magnetic field (H_{W}), through the coupling with the spins of the FM phase 2, which have been previously aligned by H_{W}. Of course, different solutions may be contemplated within the scope of the present invention for heating said predefined portions of the AF layer 1 and allowing same to cool down, respectively; for instance, instead of keeping hot said heating tip and scanning same on the substrate 10, said heating tip 20 could be alternatively heated and cooled down once positioned on one or more of said predefined portions.

Upon removal of the writing field H_{W}, (FIG. 1c) the direction of the spins within the FM layer 2 is determined by the unidirectional magnetic anisotropy set by the AF phase 1 via the exchange bias. In case of heating well above T_{B}, this implies that the area scanned by the hot tip 20 of the SPM will have the CoFeB spins (arrows identified by reference numerals (6)) antiparallel to those of the surrounding film portion (spins identified by reference numerals (7)), still in the initial state. The local hysteresis loop is then shifted to the right by a new exchange bias field Hₑₚ (FIG. 1e).

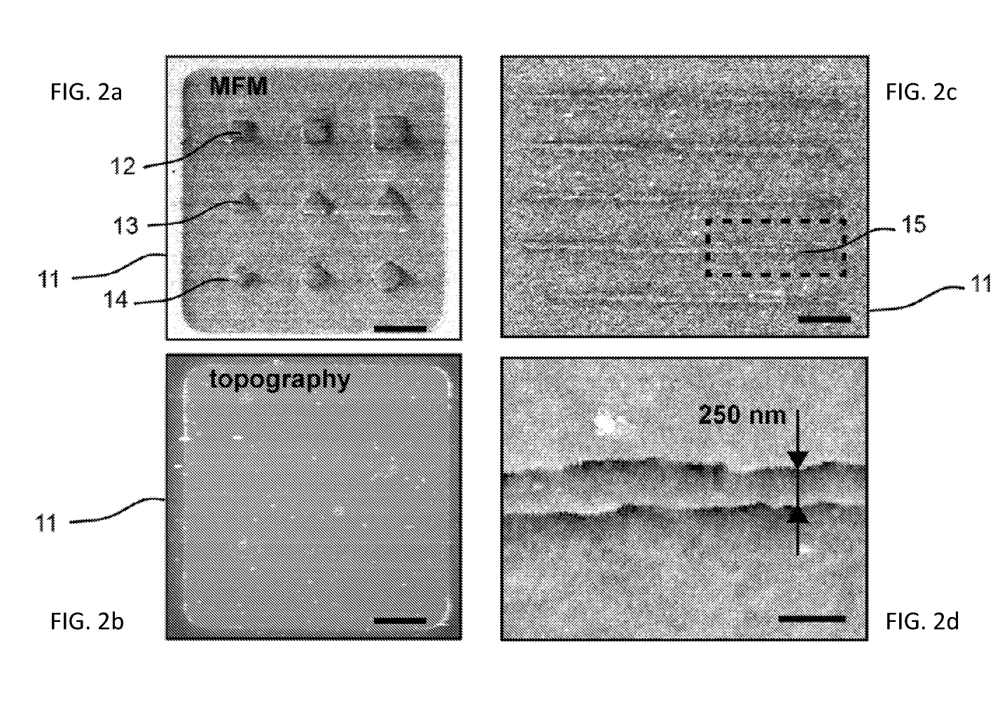

The writing capabilities of the method according to the embodiment of the present invention described above and depicted in FIG. 1 are demonstrated in FIG. 2. To facilitate navigation over the sample or substrate, patterned square pads 11 of 20 micron were patterned first by optical lithography. Then, the tam-SPL method according to the present invention was carried out to pattern, inside said square pads 11, squares, triangles and diamonds structures 12, 13, 14 with different size, from 1.5 μm to 2.5 μm (FIG. 2a). The cantilever heater temperature T_{H} (i.e. the temperature of the hot tip 20, see FIG. 1) was 560° C., 675° C. and 765° C. for squares, triangles and diamonds shapes, respectively, and the writing field H_{W} was antiparallel to the initialization field Hᵢ, in such a way to write domains with antiparallel remanent magnetization with respect to the reference direction set during the initialization. In FIG. 2a the MFM image taken under zero external field (remanent state) after writing is shown. As apparent, the magnetic contrast of the patterned areas presents dark regions on the right of each figure, while the big pad has a dark contrast on the left part. Being the magnetic contrast as seen by MFM related to the polarity of the demagnetizing stray field originating from the sample, this is a first indication that the outcome of the tam-SPL method according to the present invention and in the experimental conditions described above, is the writing of regions with opposite remanent magnetization. In FIG. 2b the topography of the same area 11 after patterning is presented: in this case no contrast is visible, thus revealing that the tam-SPL method according to the present invention does not affect the morphology of the films and/or substrates. In the MFM image, even though diamonds 14 have been written at much higher temperature than squares 12, the final magnetic contrast is the same for all patterned structures, thus indicating that the temperature range which can be used for patterning is broad. This is crucial for future applications, as a very demanding control over the tip temperature is not required.

The spatial resolution of the tam-SPL method according to the present invention has been assessed by writing single lines 15, 250 nm wide, as shown in FIGS. 2c and 2d, where the case is reported, of single lines 15 written by scanning the hot tip 20 parallel to Hᵢ, with a spacing of 2 μm between them.

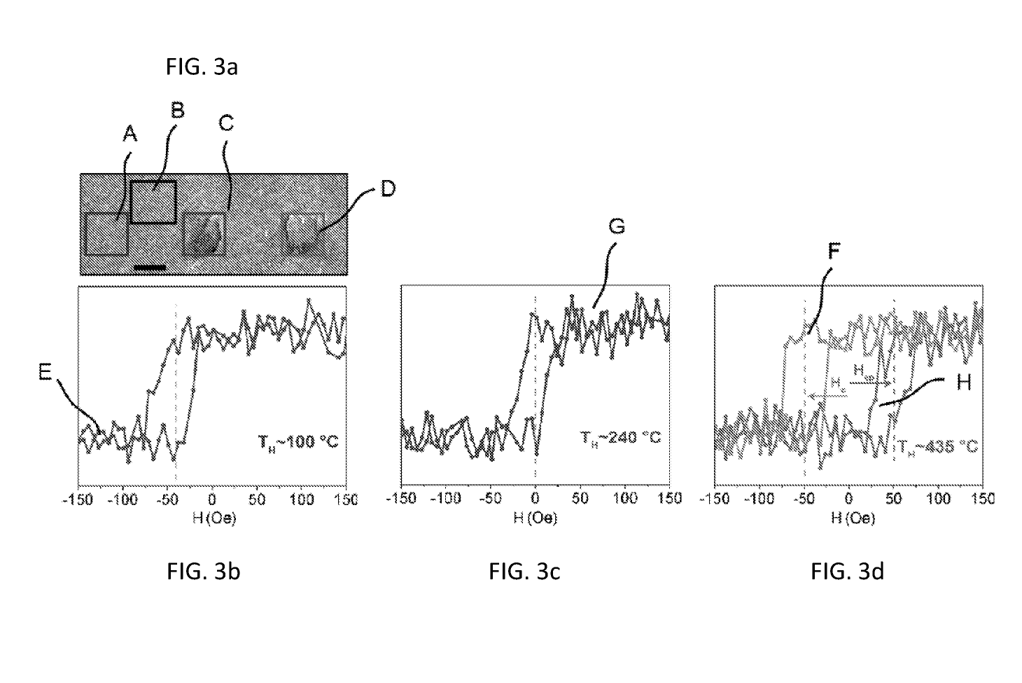

The tunability of the magnetic anisotropy landscape which can be patterned via the tam-SPL method according to the present invention is instead demonstrated in FIG. 3. FIG. 3a shows the MFM image taken in remanence from squared areas patterned with T_{H}=100° C., 240° C. and 435° C., from the left to the right, while applying H_{w}=700 Oe. For 100° C., leading to a sample local temperature well below the blocking temperature of the exchange bias system (160° C.), no magnetic contrast is seen (square A in FIG. 3a)). Correspondingly, the local hysteresis loop measured with p-MOKE in the patterned area A while sweeping the magnetic field parallel to anisotropy direction (curve E in FIG. 3b) is very similar to the loop (curve F in FIG. 3d) measured in the adjacent non-patterned area B in FIG. 3a. The middle patterned area C, written with the tip at 240° C., shows instead some magnetic contrast by MFM. For this condition of patterning it has been possible to set zero exchange bias field (curve G in FIG. 3c). By increasing T_{H} up to 435° C. (square D) the magnetic contrast increases and the local hysteresis loop definitely shifts to the right (curve H in FIG. 3d), showing the full inversion of the exchange bias field, in agreement with data in FIG. 2. Within the framework of the present invention, by tuning the heater temperature during writing, it is therefore possible to pattern very complex magnetic anisotropy landscapes in a continuous multilayer. Note that, by performing local field cooling in a writing field set not at 180 degrees from the UA, but at a different angle, it is also possible to pattern areas with the unidirectional anisotropy axis arbitrarily oriented with respect to the film uniaxial anisotropy.

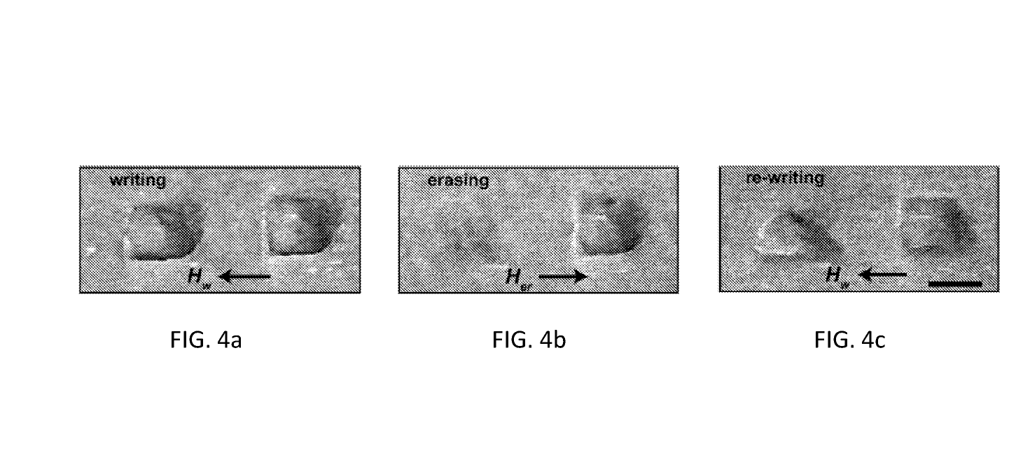

The reversibility of tam-SPL is illustrated in FIG. 4. In FIG. 4a there is shown the MFM image under zero external field of two squares patterned as described above from a “clean blackboard” state after uniform exchange bias initialization, with T_{H}=600° C. and a writing field H_{w}=700 Oe. FIG. 4b shows the MFM image of the very same area after local cancellation of the left square, by scanning the area defined by the dashed square with T_{H}=600° C. in an erasing field Hₑᵣ=−700 Oe, opposite to H_{W}, and parallel to Hᵢ. The magnetic contrast almost completely disappears indicating that a local cancellation of the pattern has been achieved. FIG. 4c, instead, shows that it is possible to re-write the erased area with another shape (a triangle in this case) by scanning the selected area again with T_{H}=600° C. under an applied field H_{w}=700 Oe. The whole pattern can be completely erased by performing a uniform field cooling which re-initializes the multilayer.

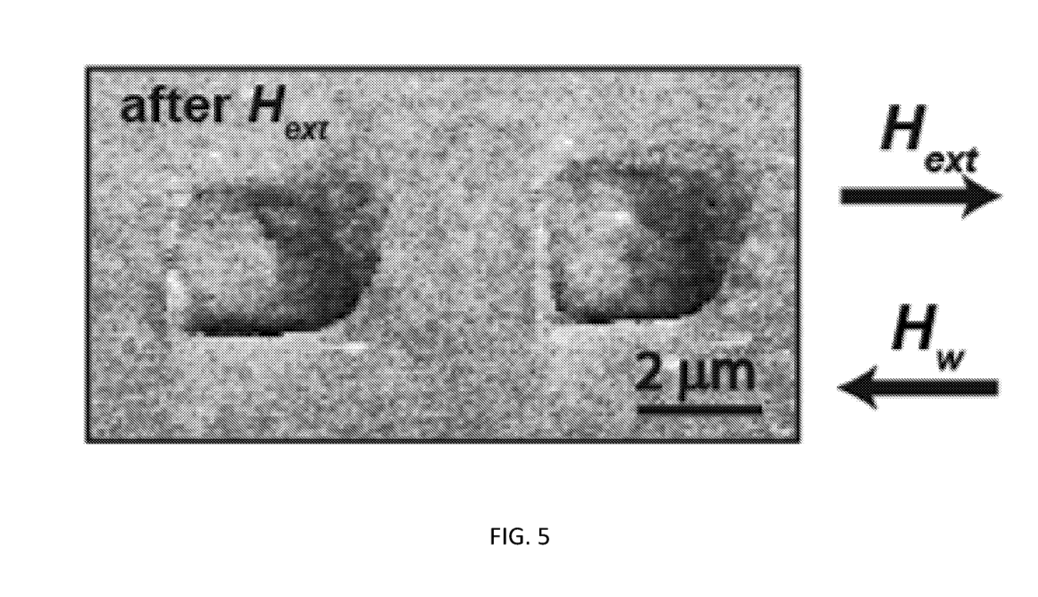

The stability of the tam-SPL patterns to high external magnetic field has been assessed by measuring the patterns before and after the application of an external magnetic field along different directions with respect to H_{w}. FIG. 5 shows the MFM measurements of square 2×2 m² patterns written with H_{w}=700 Oe after the application and subsequent removal of Hₑₓₜ=−1700 Oe antiparallel to H_{w}. The patterns are still visible and stable after the application of the external perturbation.

### Embodiments

### Sample Fabrication and Characterization

CoFeB 5 nm/IrMn 7 nm/Ru 2 nm stacks were deposited on Si/SiO₂ 1000 nm substrates by DC magnetron sputtering using an AJA Orion8 system with a base pressure below 1×10⁻⁸ Ton. During the deposition, a 300 Oe magnetic field (H_{G}) was applied in the sample plane for setting the magnetocrystalline uniaxial anisotropy (UA) direction in the CoFeB layer and the exchange bias direction in the as-grown sample. Numbered squared structures with a 400 μm² area were microfabricated by optical lithography and ion milling, for allowing the individuation of the magnetic patterns defined by tam-SPL. After microfabrication, in order to set a unidirectional anisotropy axis (UD) in the CoFeB film, the samples underwent a field cooling starting from 220° C. (above the blocking temperature T_{B}) in vacuum in a 4000 Oe magnetic field Hᵢ applied along the uniaxial anisotropy axis of the CoFeB film.

### Tam-SPL patterning

Thermally assisted magnetic scanning probe lithography was performed with a modified Agilent 5500 SPM system equipped with silicon SPM cantilevers integrated with a Joule-heating resistive heater. A National Instruments® NI cDAQ-9178 was used for controlling and recording the heating current in the cantilever. In order to pattern arbitrary two dimensional geometries, such as lines or polygons, MATLAB® scripts in combination with Agilent PicoView software were used. Patterns were performed raster-scanning the heated tip in contact mode. The writing field H_{W} was a uniform 700 Oe external magnetic field applied in the sample plane. An arbitrary angle between the direction of external field and the exchange bias direction of the sample was set by physically rotating the sample with respect to the magnets.

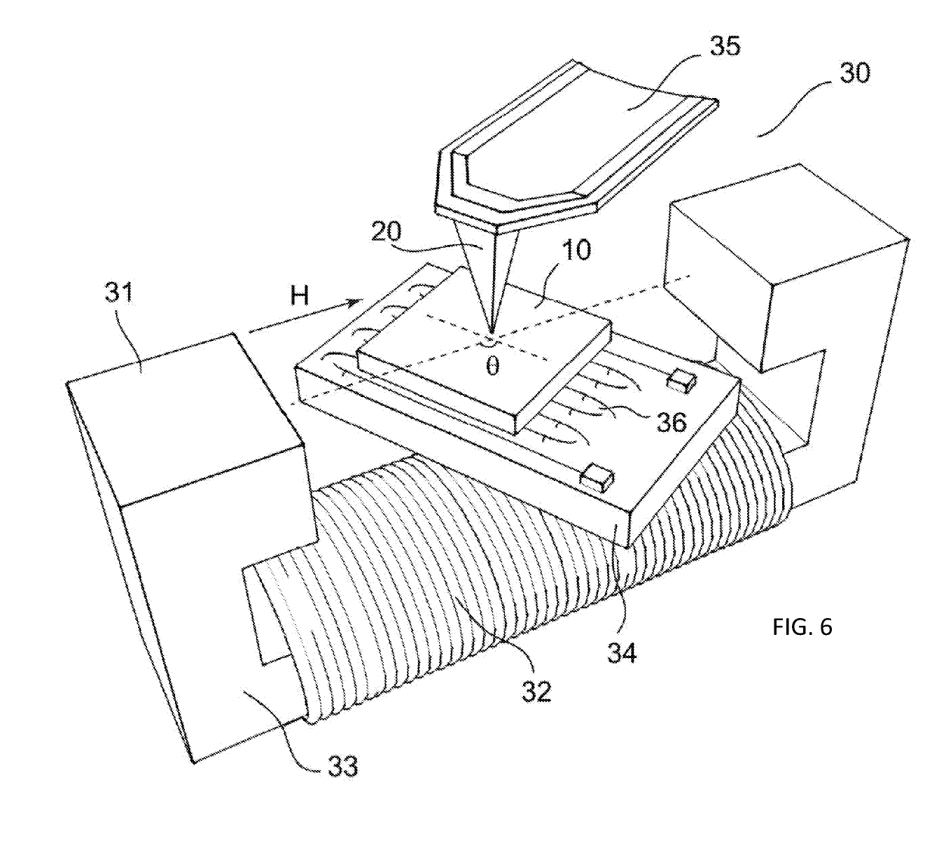

In the following, description will be given with reference to FIG. 6 of an example of equipment for the magnetic nanopatterning of a substrate according to a method as described above.

As apparent from FIG. 6, the equipment 30 depicted therein comprises essentially means 31 for generating a magnetic field H, said means 31 comprising essentially a coil 32 wound on a metal core 33, so that a magnetic field oriented as indicated by the arrow H is generated due to the electrical current traveling along the coil 32. The means 31 are adapted to generate each of the magnetic fields Hᵢ and H_{W} to be generated according to the method. In this respect, it has to be noted that the equipment comprises a support 34 by means of which the substrate 10 to be nanopatterned can be positioned between the end portions of the metal core 33 so as to be exposed to one of the magnetic fields Hᵢ, H_{W} as the need arises, i.e. depending on the method step to be carried out. In particular, and still as apparent from FIG. 6, the support 34 may be oriented at any angle with respect to the dashed line connecting the two opposite end portions of the metal core 33, meaning that the substrate 10 can be oriented at any angle with respect to the direction of the magnetic filed H (one of the magnetic fields Hᵢ and H_{W}). Moreover, the support 34 is adapted to be rotated on a rotation axis parallel to the dashed line as depicted.

The equipment further comprises a movable arm 35, for instance a cantilever, by means of which the heating tip 20 may be kept close to or in contact with the substrate 10, or even scanned on the substrate 10, according to the needs and/or circumstances, in particular according to the particular method step to be carried out. For the purpose of heating predefined portions of the substrate 10, the heating tip 20 (for instance comprising an electrical resistance, not depicted) may be kept at a predefined heating temperature (enough to heat said predefined portions of the substrate 10) and scanned on the substrate 10; alternatively, the heating tip 20 may be alternatively heated (by activating the electrical resistance) and allowed to cool down (by turning off the electrical resistance) and positioned in correspondence of each portion of the substrate 10 to be heated.

Said means 20 can be, other than a heatable tip, also a means able to focalize a laser beam on the predefined portion of the substrate 10 (e.g. a scanning near-field optical microscope tip). Said focalized laser beam being able to heat predefined portion of said substrate 10.

For the purpose of heating the entire substrate 10 (according to the method step to be carried out, for instance to heat the same to a temperature above the blocking temperature), the support 34 further comprises a heater 36, for instance comprising one or more electrical resistances.

By means of the generating means 31 each of the magnetic fields Hᵢ or H_{W} can be alternatively generated and removed, for instance by turning on and off the generating means 31, respectively.

To summarize, the present invention introduces a novel nano-fabrication tool for non-destructive, reversible nanopatterning of magnetic domains in a continuous medium, based on the local field cooling performed by scanning the surface of an exchange bias system with the hot tip of a scanning probe microscope. In particular, the present invention offers: (i) the capability of patterning sub-micron features with different shape and minimum width in the nanometer range; (ii) the possibility of finely tuning the local magnetic anisotropy by tuning the tip temperature; (iii) the capability of writing domains with magnetization along the arbitrary writing field direction, thus implementing a multiple magnetic state memory; (iii) the stability of the domain pattern to external magnetic perturbations; (iv) the reversibility and local reconfigurability of the method.

1-19. (canceled)

20. A method for magnetic nanopatterning of a substrate, the substrate comprising a ferromagnetic or ferrimagnetic phase and an antiferromagnetic phase, the ferromagnetic or ferrimagnetic phase and the antiferromagnetic phase being coupled by exchange bias in such a way to form an exchange bias system; the method comprising:
submitting the substrate to a magnetic field oriented at any angle with respect to a reference direction of the substrate so as to set the magnetization of the ferromagnetic or ferrimagnetic phase in the direction of the magnetic field, while heating predefined portions of the antiferromagnetic phase up to a writing temperature at which the exchange bias can be influenced;
allowing the predefined portions of the antiferromagnetic phase to cool down to a temperature below the writing temperature;
removing the magnetic field.

21. (canceled)

22. The method of claim 20, wherein the ferromagnetic or ferrimagnetic phase and the antiferromagnetic phase correspond to different antiferromagnetic and ferromagnetic or ferrimagnetic phases, chemically or structurally identified, within a composite material.

23. (canceled)

24. The method of claim 20, wherein the substrate is a multilayer and each of the antiferromagnetic and ferromagnetic or ferrimagnetic phases to a layer in the multilayer.

25. (canceled)

26. (canceled)

27. The method of claim 20, wherein
the magnetic field is either static and uniform over the whole substrate or static and inhomogeneous over the whole substrate or time-dependent and uniform over the whole substrate.

28. (canceled)

29. (canceled)

30. The method of claim 20,
wherein the predefined portions of the anti-ferromagnetic phase are heated by means of a which is kept close to or in contact with the surface of the substrate.

31. The method of claim 30, wherein the comprises a heating tip, wherein the heating tip is kept to a temperature suitable to heat the predefined portions of the antiferromagnetic phase up to a temperature which is high enough to influence the exchange bias and wherein the heating tip is scanned on the substrate.

32. (canceled)

33. (canceled)

34. (canceled)

35. The method of claim 31,
wherein, due to the heating tip being scanned on the substrate, as said heating tip moves from a heated portion to the next portion to be heated, the predefined portions of the antiferromagnetic phase previously heated by the heating tip are allowed to cool down to one of a temperature below the writing temperature and room temperature.

36. An equipment for magnetic nanopatterning of a substrate the substrate comprising a ferromagnetic or ferrimagnetic phase and an antiferromagnetic phase provided on the ferromagnetic or ferrimagnetic phase, the ferromagnetic or ferrimagnetic phase and the antiferromagnetic phase being coupled by exchange bias in such a way to form an exchange bias system; the equipment comprising:
means for generating a first magnetic field so as to expose the substrate—to the first magnetic field;
means for heating the substrate to both a temperature above the room temperature and a temperature above a blocking temperature of the exchange bias system whilst the substrate is exposed to the first magnetic field;
means for allowing the substrate to cool down to both a temperature below the blocking temperature of the exchange bias system and a room temperature of the substrate whilst the substrate is still exposed to the first magnetic field so as to set the unidirectional anisotropy and shift the hysteresis loop of the substrate, thus initializing the substrate;
means for removing the first magnetic field;
means for generating a second magnetic field oriented at any angle with respect to the first magnetic field so as to expose the substrate to the second magnetic field, thus setting the magnetization of the ferromagnetic or ferrimagnetic phase in the direction of the second magnetic field, said means being adapted to generate one of uniform or inhomogeneous and static or time dependent second magnetic field;
means for heating predefined portions of the antiferromagnetic phase up to a writing temperature above both room temperature and the blocking temperature whilst the substrate is exposed to the second magnetic field;
means for allowing the predefined portions of the antiferromagnetic phase to cool down to a temperature below both the writing temperature and the blocking temperature;
means for removing the second magnetic field.

37. The equipment of claim 36, wherein the means for heating the substrate to both a temperature above the blocking temperature of the exchange bias system and a temperature above the room temperature of the substrate, and the means for allowing the substrate to cool down to both a temperature below the blocking temperature of the exchange bias system and a room temperature of the substrate comprise a heating support adapted to be alternatively heated and allowed to cool down.

38. The equipment of claim 37, wherein the heating support is adapted to be oriented at any angle with respect to the first magnetic field, and/or the second magnetic field.

39. The equipment of claim 36, wherein the means for heating the predefined portions of the antiferromagnetic phase, comprises a adapted to be kept close to or in contact with the surface of the exchange bias system.

40. (canceled)

41. (canceled)

42. The equipment of claim 39, wherein the comprises a heating tip, and wherein the heating tip is adapted to be scanned on the exchange bias system.

43. (canceled)

44. (canceled)

45. The equipment of claim 39, wherein the comprises means adapted to focalize a laser beam, and wherein the focalizing means are adapted to be scanned on the exchange bias system.

46. (canceled)

47. (canceled)

48. The equipment of claim 45, wherein the further comprises a scanning near-field optical microscope tip.

49. (canceled)

50. (canceled)

51. A magnetically patterned substrate, the substrate comprising a ferromagnetic phase and an antiferromagnetic phase of one or more materials; wherein within predefined portions of the substrate an exchange bias field between the antiferromagnetic phase and the ferromagnetic phase is antiparallel to an exchange bias field between the antiferromagnetic phase and the ferromagnetic phase outside the predefined portions.

52. The substrate of claim 51, wherein within the predefined portions the spins of the ferromagnetic phase are either antiparallel or directed at any angle with respect to the spins of the ferromagnetic phase outside the predefined portions.

53. A method for magnetic nanopatterning of a substrate, the substrate comprising a ferromagnetic or ferrimagnetic phase and an antiferromagnetic phase, the ferromagnetic or ferrimagnetic phase and the antiferromagnetic phase being coupled by exchange bias in such a way to form an exchange bias system; the method comprising:
submitting the substrate to a magnetic field oriented at any angle with respect to a reference direction of the substrate so as to set the magnetization of the ferromagnetic or ferrimagnetic phase in the direction of the magnetic field, while heating predefined portions of the antiferromagnetic phase up to a writing temperature at which the exchange bias can be influenced;
allowing the predefined portions of the antiferromagnetic phase to cool down to a temperature below the writing temperature;
removing the magnetic field, wherein the reference direction of said substrate is set by initializing the substrate by submitting the substrate to a further magnetic field while heating the substrate above a blocking temperature of the exchange bias system and then cooling the substrate to a temperature below the blocking temperature, thus setting the unidirectional anisotropy of the ferromagnetic or ferrimagnetic phase and shifting the hysteresis loop of the substrate, and removing the further magnetic field.

54. The method of claim 53, wherein the ferromagnetic or ferrimagnetic phase and the antiferromagnetic phase correspond to different antiferromagnetic and ferromagnetic or ferrimagnetic phases, chemically or structurally identified, within a composite material.

55. The method of claim 53, wherein the substrate is a multilayer and each of the antiferromagnetic and ferromagnetic or ferrimagnetic phases correspond to a layer in the multilayer.

56. The method of claim 53, wherein the magnetic field is either static and uniform over the whole substrate or static and inhomogeneous over the whole substrate or time-dependent and uniform over the whole substrate.

57. The method of claim 53, wherein the magnetic fields and the further magnetic field are either parallel to the surface of the substrate or form an arbitrary angle with the direction perpendicular to the surface of the substrate.

58. The method of claim 53, wherein the magnetic fields is either oriented at any angle with respect to the further magnetic field or antiparallel to the further magnetic field or parallel to the further magnetic field.

59. The method of claim 53, wherein the predefined portions of the antiferromagnetic phase are heated by means of a heating tool which is kept close to or in contact with the surface of the substrate.

60. The method of claim 59, wherein the heating tool comprises a heating tip, wherein the heating tip is kept to a temperature suitable to heat the predefined portions of the antiferromagnetic phase up to a temperature which is high enough to influence the exchange bias and wherein the heating tip is scanned on the substrate.

61. The method of claim 60, wherein, due to the heating tip being scanned on the substrate, as said heating tip moves from a heated portion to the next portion to be heated, the predefined portions of the antiferromagnetic phase previously heated by the heating tip are allowed to cool down to one of a temperature below the writing temperature and the temperature below the blocking temperature and room temperature.

62. An equipment for magnetic nanopatterning of a substrate, the substrate comprising a ferromagnetic or ferrimagnetic phase and an antiferromagnetic phase provided on the ferromagnetic or ferrimagnetic phase, the ferromagnetic or ferrimagnetic phase and the antiferromagnetic phase being coupled by exchange bias in such a way to form an exchange bias system; the equipment comprising:
means for generating a first magnetic field so as to expose the substrate to the first magnetic field;
means for heating the substrate to both a temperature above the room temperature and a temperature above a blocking temperature of the exchange bias system whilst the substrate is exposed to the first magnetic field;
means for allowing the substrate to cool down to both a temperature below the blocking temperature of the exchange bias system and a room temperature of the substrate whilst the substrate is still exposed to the first magnetic field so as to set the unidirectional anisotropy and shift the hysteresis loop of the substrate, thus initializing the substrate;
means for removing the first magnetic field;
means for generating a second magnetic field oriented at any angle with respect to the first magnetic field so as to expose the substrate to the second magnetic field, thus setting the magnetization of the ferromagnetic or ferrimagnetic phase in the direction of the second magnetic field, said means being adapted to generate one of uniform or inhomogeneous and static or time dependent second magnetic field,
means for heating predefined portions of the antiferromagnetic phase up to a writing temperature above both room temperature and the blocking temperature whilst the substrate is exposed to the second magnetic field;
means for allowing the predefined portions of the antiferromagnetic phase to cool down to a temperature below both the writing temperature and the blocking temperature;
means for removing the second magnetic field, wherein the means for heating the substrate to both a temperature above the blocking temperature of the exchange bias system and a temperature above the room temperature of the substrate, and the means for allowing the substrate to cool down to both a temperature below the blocking temperature of the exchange bias system and a room temperature of the substrate comprise a heating support adapted to be alternatively heated and allowed to cool down.

63. The equipment of claim 62, wherein the heating support is adapted to be oriented at any angle with respect to the first magnetic field and/or the second magnetic field.

64. The equipment of claim 62, wherein the means for heating the predefined portions of the antiferromagnetic phase comprises a heating tool adapted to be kept close to or in contact with the surface of the exchange bias system.

65. The equipment of claim 64, wherein the heating tool comprises a heating tip, and wherein the heating tip is adapted to be scanned on the exchange bias system.

66. The equipment of claim 64, wherein the heating tool comprises means adapted to focalize a laser beam, and wherein the focalizing means are adapted to be scanned on the exchange bias system.

67. The equipment of claim 66, wherein the heating tool further comprises a scanning near-field optical microscope tip.
